(19) United States
(12) Patent Application Publication
(10) Pub. No.: US 2004/0076367 A1
(43) Pub. Date: Apr. 22, 2004

(54) Silicon optical bench for packaging optical switch device, optical switch package using the silicon optical bench, and method for fabricating the silicon optical bench

(76) Inventors: Yong-sung Eom, Daejeon-city (KR); Heung-woo Park, Seoul (KR); Jong-hyun Lee, Daejeon-city (KR); Ho-gyeong Yun, Jeonrabuk-do (KR); Byung-seok Choi, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/454,039

(22) Filed: Jun. 4, 2003

(30) Foreign Application Priority Data
Oct. 21, 2002 (KR) 2002-64259

(51) Int. Cl. G02B 6/35

(52) U.S. Cl. 385/18; 385/16

(57) ABSTRACT

A silicon optical bench for packaging an optical switch device is provided. The silicon optical bench includes a silicon substrate. The silicon substrate includes a first region where the optical switch device will be installed, a second region placed on a first side of the first region so as to allow an optical input unit to be installed therein, and a third region placed on a second side of the first region so as to allow an optical output unit to be installed therein. Here, a cavity is formed in the first region through the silicon substrate, and grooves are arranged in the second and third regions of the silicon substrate so that a lens and an optical fiber for defining optical fibers can be installed in the grooves.

### BACKGROUND OF THE INVENTION

This application claims the priority of Korean Patent Application No. 2002-64259, filed Oct. 21, 2002, in the Korean Intellectual Property Office, the disclosure of which is incorporated herein in its entirety by reference.

1. Field of the Invention

The present invention relates to a silicon optical bench for packaging an optical switch device, an optical switch package using the silicon optical bench, and a method for fabricating the silicon optical bench

2. Description of the Related Art

In accordance with the development in micro-opto-electro-mechanical-system (MOEMS) techniques, various optical devices and systems have been suggested. One of the optical devices and systems is an optical switch using micromirrors. An optical switch using micromirrors has been welcomed more than other optical devices having been used for optical communications because the optical switch shows a low optical interference and a low sensitivity to wavelengths and polarized light and has low manufacturing costs.

An optical switch using micromirrors has a structure where micromirrors are and a driving unit for driving the micromirrors are arranged on a silicon substrate. In the optical switch, an input unit, into which light beams are input, and an optical output unit, from which the light beams reflected by the micromirrors are output, are integrated into a module so as to constitute an optical package. However, it is necessary to manufacture such an optical switch package that the optical switch including the micromirrors, the input unit, and the optical output unit are precisely aligned with one another. In other words, the optical switch, the optical input unit, and the output unit must be arranged so that they can be prevented from deviating from a desired path of light beams. If the optical switch, the optical input unit, and the output unit are out of the desired path of light beams, unwanted optical switching results may be caused. However, it is not easy to precisely align an optical switch, an optical input unit, and an optical output unit, which are separate from one another, with a desired path of light beams.

### SUMMARY OF THE INVENTION

The present invention provides a silicon optical bench for packaging an optical switch device so that the optical switch device, an optical input unit, and an optical output unit can be precisely aligned with one another.

The present invention also provides an optical switch package using the silicon optical bench.

The present invention also provides a method for fabricating the silicon optical bench.

According to an aspect of the present invention, there is provided a silicon optical bench for packaging an optical switch device. The silicon optical bench includes a silicon substrate. The silicon substrate includes a first region where the optical switch device will be installed, a second region placed on a first side of the first region so as to allow an optical input unit to be installed therein, and a third region placed on a second side of the first region so as to allow an optical output unit to be installed therein. Here, a cavity is formed in the first region through the silicon substrate, and grooves are arranged in the second and third regions of the silicon substrate so that a lens and an optical fiber for defining optical fibers can be installed in the grooves.

Preferably, the silicon substrate has a rectangle shape.

Preferably, the silicon optical bench further includes a plurality of terminals arranged on the other two sides of the silicon substrate so that the plurality of terminals will contact electrodes of an optical switch device to be packaged.

Preferably, the silicon optical bench further includes alignment marks arranged on the silicon substrate between the plurality of terminals and the first region and used as an indication mark when aligning the optical switch device with the silicon substrate.

Preferably, the grooves are formed as a rectangle shape or a V-shape (or the grooves are formed to have a rectangle-shaped or V-shaped cross-section.

Preferably, the silicon optical bench further includes a groove for providing a path of parallel light beams, which is formed between the first region of the silicon substrate and the groove where the lens will be installed.

According to another aspect of the present invention, there is provided an optical package including an optical switch device and a silicon optical bench. The optical switch device includes micromirrors arranged on its surface in a matrix and electrodes for driving the micromirrors formed along its edge. The silicon optical bench includes a silicon substrate which includes a first region where the optical switch device will be installed, a second region placed on a first side of the first region so as to allow an optical input unit to be installed therein, and a third region placed on a second side of the first region so as to allow an optical output unit to be installed therein, a cavity formed in the first region through the silicon substrate, grooves arranged in the second and third regions of the silicon substrate so as to be aligned with an optical path, and a lens and an optical fiber for defining optical fibers.

Preferably, the optical switch package further includes a plurality of terminals arranged on the silicon substrate on sides of the silicon substrate opposite to the second and third regions so that the plurality of terminals contact electrodes of the optical switch device.

Preferably, the silicon optical further includes alignment marks arranged on the silicon substrate between the plurality of terminals and the first region and used as an indication mark when aligning the optical switch device with the silicon substrate.

Preferably, the silicon optical bench further includes a groove for providing a path of parallel light beams, which is formed between the first region of the silicon substrate and the groove where the lens will be installed.

Preferably, the lens and the optical fiber are integrated into one body.

Preferably, the optical switch device further includes a protector surrounding the micromirrors.

Preferably, the protector is made of glass.

According to still another aspect of the present invention, there is provided a method for fabricating a silicon optical bench. A thermal oxide layer is formed on a first surface and a second surface of a silicon substrate having a (100) crystal orientation. A metal layer pattern is formed on the thermal oxide layer on the first surface of the silicon substrate. A first mask layer pattern is formed on the thermal oxide layer and the metal layer pattern on the first surface of the silicon substrate. A first region of the silicon substrate is exposed by removing part of the thermal oxide layer exposed by the first mask layer pattern using the first mask layer pattern as an etching mask. A second mask layer is formed on the exposed surface of the silicon substrate and the first mask layer pattern. A second mask layer pattern is formed by patterning the second mask layer. A second region of the silicon substrate is exposed by removing part of the first mask layer pattern and the thermal oxide layer using the second mask layer pattern as an etching mask. A protective layer is formed on the thermal oxide layer on the second surface of the silicon substrate. A first etching process is performed so as to etch the exposed part of the second region of the silicon substrate to a predetermined depth. The first region of the silicon substrate is exposed by removing part of the second mask layer pattern. A second etching process is performed so as to etch the exposed part of the first region of the silicon substrate to a predetermined depth and to completely remove the exposed part of the second region. The second mask layer pattern, the first mask layer pattern, and the protective layer are removed.

Preferably, the first mask layer pattern and the protective layer are formed by forming a nitride layer or an oxide layer through sputtering.

Preferably, the second mask layer is formed of an aluminum layer.

Preferably, the first and second etching processes are performed using the second mask layer pattern as an etching mask by following a wet etching method using a TMAH solution and a KOH solution.

Preferably, the wet etching method is performed so that the direction of the etching process forms an angle of 45 degrees with a flat zone of a silicon wafer.

Preferably, the first and second etching processes are performed by using an inductively coupled plasma-reactive ion etching (ICP-RIE) method or a deep-reactive ion etching (D-RIE) method.

### BRIEF DESCRIPTION OF THE DRAWINGS

The above features and advantages of the present invention will become more apparent by describing in detail exemplary embodiments thereof with reference to the attached drawings in which:

FIG. 1 is a layout of a silicon optical bench for packaging an optical switch device according to a preferred embodiment of the present invention;

FIG. 2 is a cross-sectional view taken along line II-II′ of FIG. 1;

FIG. 3 is a cross-sectional view taken along line III-III′ of FIG. 1;

FIG. 4 is a cross-sectional view taken along line IV-IV′ of FIG. 1;

FIG. 5 is a cross-sectional view taken along line V-V′ of FIG. 1;

FIG. 6 is a layout of an optical switch package using a silicon optical bench according to a preferred embodiment of the present invention;

FIG. 7 is a cross-sectional view taken along line VII-VII′ of FIG. 6;

FIG. 8 is a cross-sectional view taken along line VIII-VIII′ of FIG. 6;

FIG. 9 is a layout of the optical switch package shown in FIG. 6, from which an optical switch device and a lens supporter are removed;

FIG. 10 is a layout of an optical switch device of the optical switch package shown in FIG. 6;

FIG. 11 is a cross-sectional view taken along line XI-XI′ of FIG. 10;

FIG. 12 is a diagram illustrating a lens and an optical fiber of the optical switch package shown in FIG. 6;

FIGS. 13 through 19 are cross-sectional views illustrating a method for fabricating a silicon optical bench according to a preferred embodiment of the present invention; and

FIG. 20 is a diagram illustrating an example of an etching process shown in FIGS. 17 and 18.

### DETAILED DESCRIPTION OF THE INVENTION

The present invention will be described more fully with reference to the accompanying drawings, in which preferred embodiments of the invention are shown. The invention may, however, be embodied in many different forms and should not be construed as being limited to the embodiments set forth herein.

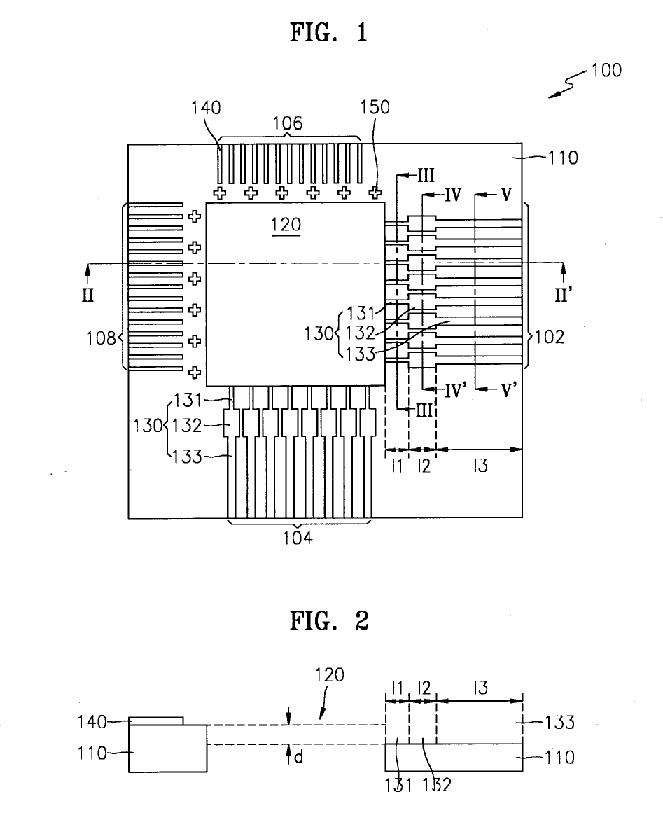

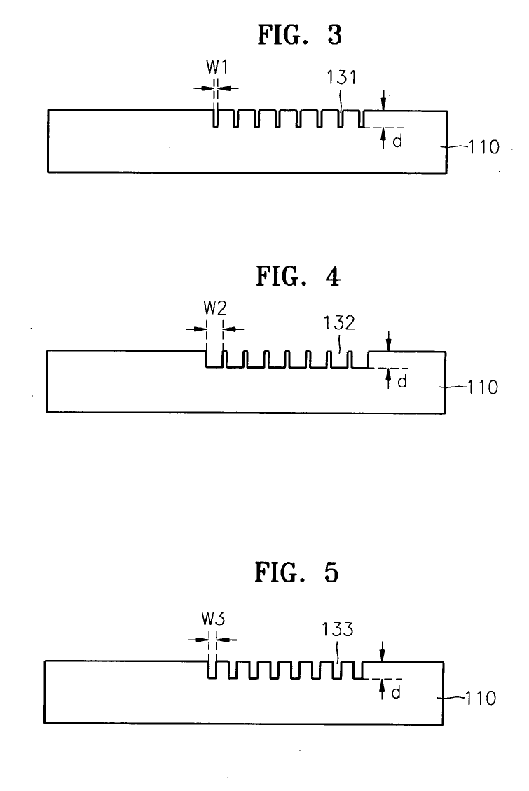

FIG. 1 is a layout of a silicon optical bench for packaging an optical switch device according to a preferred embodiment of the present invention. FIGS. 2 through 5 are cross-sectional views taken along lines II-II′, III-III′, IV-IV′, and V-V′, respectively, of FIG. 1.

Referring to FIGS. 1 through 5, a silicon optical bench 100 is formed of a silicon substrate 110 having a rectangle shape. A cavity 120 is arranged slightly out of the middle portion of the silicon substrate 110. An optical switch having micromirrors is mounted on the silicon optical bench 100 through the cavity 120. An optical input unit 102 is located on the right-hand side of the cavity 120, and an optical output unit 104 is located below the cavity 120. Terminal units 106 and 108 are located on the left-hand side of the cavity 120 and above the cavity 120, respectively.

Three grooves having the same depth (d) but different widths are formed in each of the optical input and output units 102 and 104. A first groove 131 extending from the cavity 120 provides a path of parallel light beams and has a first length l1 and a first width w1, which is smallest among the widths of the three grooves 131, 132, and 133. A second groove 132 extending from the first groove 131 provides a space for a lens to be built in and has a second length l2 and a second width w2, which is greatest among the widths of the three grooves 131, 132, and 133. The third groove 133 extending from the second groove 132 provides a space for an optical fiber to be built in and has a third length l3 and a third width w3, which is greater than the first width w1 but smaller than the second width w2. The first, second, and third grooves 131, 132, and 133 may have a rectangle-shaped cross-section or a V-shaped cross section. A plurality of optical path units 130 each comprised of the first, second, and third grooves 131, 132, and 133 are arranged at intervals of a predetermined distance. For example, in the case of constituting an optical switch device having an 8×8 matrix structure, 8 optical path units are arranged in each of the optical input and output units 102 and 104.

In each of the terminal units 106 and 108, a plurality of terminals 140 are arranged at intervals of a predetermined distance. Each of the terminals 140 is electrically connected to each electrode of an optical switch device to be mounted on the silicon optical bench 100 overlapping the cavity 120. Alignment marks 150 are formed between the cavity 120 and the terminals 140 so that the optical switch device can be mounted on the silicon optical bench 100 precisely at a desired position. The alignment marks 150 are shown as having a cross shape but may have a different shape as well.

According to the silicon optical bench 100 of the present invention, an optical path is set up in advance between the optical input unit 102 and a place where the optical switch device will be built, and thus there is no need to perform additional optical path alignment. In other words, light beams are input into the optical input unit 102 of the silicon optical bench 100 along an optical fiber arranged in the third groove 133, a lens arranged in the second groove 132, and the first groove 131. Since the path of the light beams input into the optical input unit 102 is fixed, the optical fiber and the lens are automatically aligned with the path of the input light beams without performing additional optical path alignment, which is directly applied to the optical output unit 104 as well.

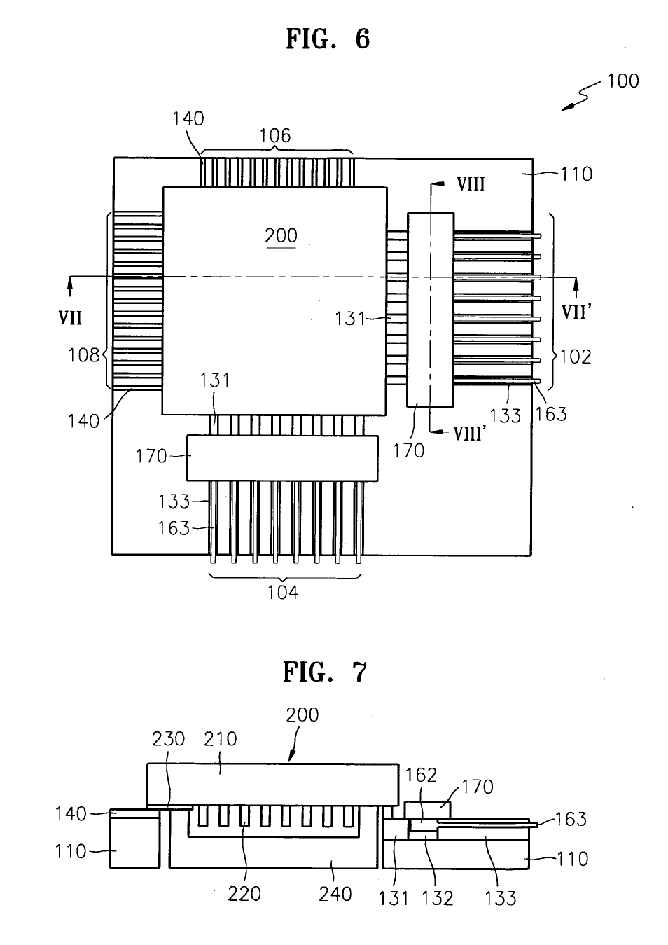

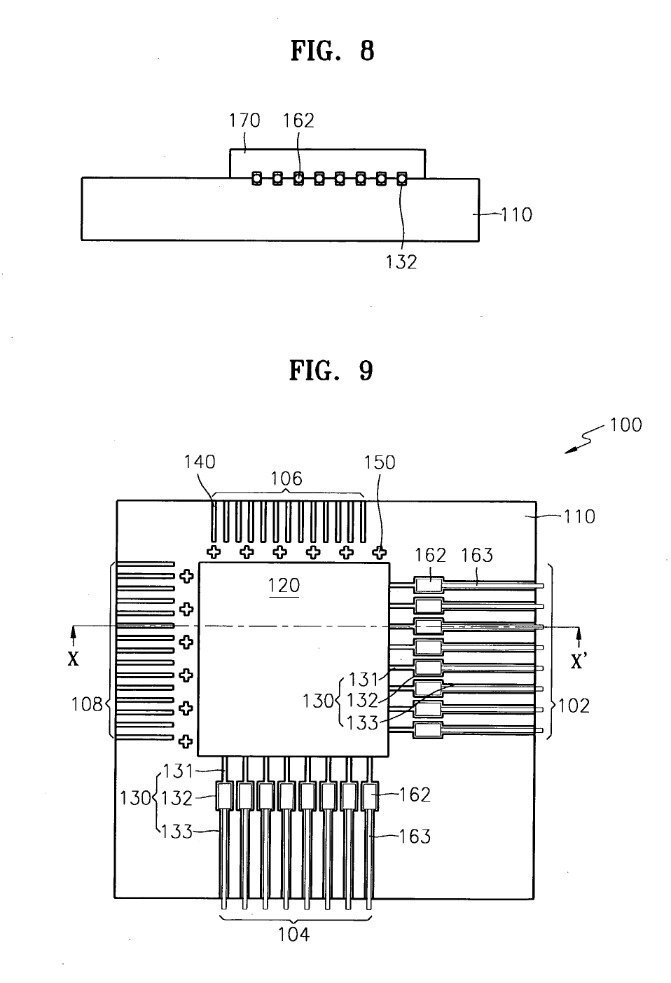

FIG. 6 is a layout of an optical switch package using a silicon optical bench according to a preferred embodiment of the present invention. FIGS. 7 and 8 are cross-sectional views taken along lines VII-VII′ and VIII-VII′, respectively, of FIG. 6.

Referring to FIGS. 6 through 8, an optical switch package according to a preferred embodiment of the present invention has a structure in which an optical switch device 200 is mounted on a silicon optical bench 100. FIG. 6 shows a rear side of the silicon optical device 200, and a frontal side of the silicon optical device 200 will be described later. The silicon optical bench 100 is formed of a silicon substrate 110 having a rectangle shape. An optical input unit 102 and an optical output unit 104 are placed on the right-hand side of the optical switch device 200 and below the optical switch device 200, respectively. Terminal units 106 and 108 are provided above the optical switch device 200 and on the left-hand side of the optical witch device 200, respectively, so as to contact electrodes of the optical switch device 200.

The optical input and output units 102 and 104 have the same structure. In each of the optical input and output units 102 and 104, a first groove 131 is formed close to the optical switch device 200, and second and third grooves 132 and 133 extend from the first and second grooves 131 and 132, respectively, so that the third groove 133 reaches the edge of the silicon substrate 110. The first groove 131 provides a path of parallel light beams. The second groove 132 provides a space for a lens 162 to be built in. The lens 162 is a graded index (GRIN) rod lens. The third groove 133 provides a space for an optical fiber 163 to be built in. The lens 162 is supported and is fixed by a lens supporter 179 completely covering the lens 162 over the lens 162. The lens supporter 170 is bonded to the silicon substrate 111 and is fixed so that an adhesive can be prevented from flowing in between the lens 162 and the lens supporter 170.

As shown in FIG. 7, the optical switch device 200 includes micromirrors 220, which are arranged on a silicon substrate 210 having a rectangle shape in the manner of an m×m matrix. Electrodes 230 for driving the micromirrors 220 are provided along an edge of the optical switch device 200. The electrodes 230 directly contact the terminals 140 of the silicon optical bench 100 so that the electrodes 230 are electrically connected to the terminals 140. In order to protect the micromirrors 220, a protector 240 is arranged on the optical switch device 200 so as to cover the micromirrors 220. The protector 240 is bonded to the optical switch device 200. The optical switch device 200 and the silicon optical bench 100 are bonded to each other through a flip chip bonding process. During the flip chip bonding process, the micromirrors 220 exposed on the surface of the optical switch device 200 may get faced with physical impact. The protector 240 is introduced to protect the micromirrors 220 from such physical impact. The protector 240 is made of glass.

FIG. 9 is a layout of the optical switch package shown in FIG. 6, from which the optical switch device 200 and the lens supporter 170 are removed. In FIGS. 6 through 9, the same reference numerals represent the same elements, and thus their description will not be repeated here.

Referring to FIG. 9, a cavity 120 exists at a predetermined place that used to be covered by the optical switch device 200 of FIG. 6. Alignment marks 150 used to align the optical switch device 200 with the silicon optical bench 100 are arranged along edges of the cavity 120. The lens 162 and the optical fiber 163 are provided in the second groove 132 and the third groove 133, respectively, formed on the silicon substrate 110. The lens 162 and the optical fiber 163, as shown in FIG. 12, are integrated into one body before being installed in the second and third grooves 132 and 133. Thereafter, the body consisting of the lens 162 and the optical fiber 163 is installed in the second and third grooves 132 and 133. In order to integrate the lens 162 and the optical fiber 163 into one body, a bonding process is performed so that an end of the lens 132 having a cylindrical shape is bonded to an end of the optical fiber 133. In the integration of the lens 132 and the optical fiber 133 into one body, a lens having a diameter of no smaller than about 500 μm and an optical fiber having a diameter of no smaller than about 125 μm are used.

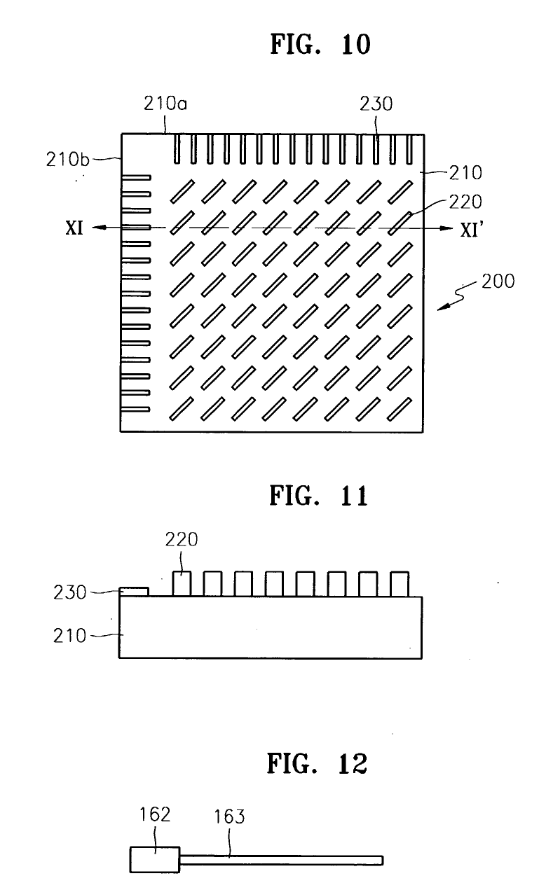

FIG. 10 is a layout of an optical switch device of the optical switch package shown in FIG. 6, and FIG. 11 is a cross-sectional view taken along line XI-XI′ of FIG. 10.

Referring to FIGS. 10 and 11, an optical switch device 200 includes a plurality of micromirrors 220 arranged on a silicon substrate 210 having a rectangle shape in the manner of an m×m matrix. In the present embodiment of the present invention, the micromirrors 220 are arranged in, for example, the manner of 8×8 matrix. The micromirrors 220 are driven by electrodes 230. The electrodes 230 are formed at a first side 210a of the silicon substrate 210 and at a second side 210b of the silicon substrate 210, which is adjacent to the first side 210a. When a bias is applied to the electrodes 230 formed at the first and second sides of the silicon substrate 210, some of the micromirrors 220 are driven so that incident light beams are reflected by the driven micromirrors 220.

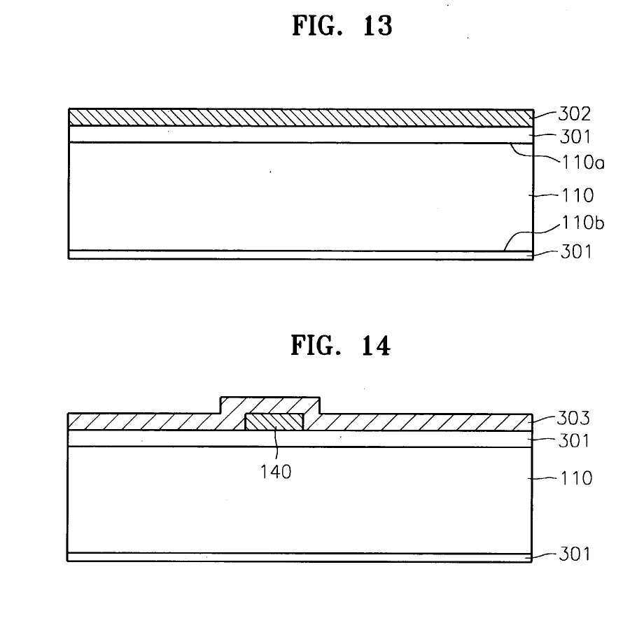

FIGS. 13 through 19 are cross-sectional views illustrating a method for fabricating a silicon optical bench according to a preferred embodiment of the present invention. Referring to FIG. 13, there is provided a silicon substrate 110 having a first surface 110a and a second surface 110b opposite to the first surface 110a. The silicon substrate 110 is formed of silicon having a (100) crystal orientation (100) in order to form a mirror device to be perpendicular to a submount plane by taking advantage of the characteristics of the silicon substrate 110 that a plane to be etched in a subsequent process of etching the silicon substrate 110 having the (100) crystal orientation is perpendicular to an anisotropic etching barrier, i.e., a (111) plane. Thereafter, a thermal oxidation process is performed on the silicon substrate 110 so as to form a thermal oxide layer 301 on the first and second surfaces 110a and 110b of the silicon substrate 110. The thickness of the thermal oxide layer 301 is about 1 μm. Thereafter, a first metal layer 302 used to form terminals is formed on the thermal oxide layer 301 on the first surface 110a of the silicon substrate 110. The first metal layer 302 may be formed of a chrome/gold (Cr/Au) thin layer.

Referring to FIG. 14, the first metal layer 302 is patterned, thus forming terminals 140. A first mask layer 303 is formed on the exposed surface of the thermal oxide layer 301 and the terminals 140. The first mask layer 303 may be formed of a nitride layer or an oxide layer through sputtering.

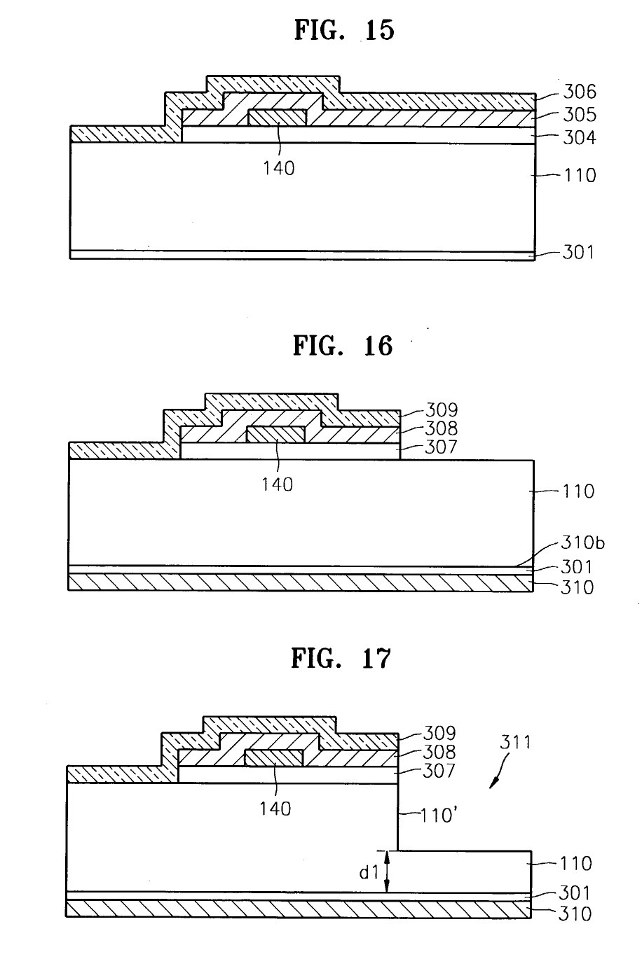

Referring to FIG. 15, the first mask layer 303 is patterned, thus forming a first mask layer pattern 305. Portions of the thermal oxide layer 301 exposed by the first mask layer pattern 305 are removed, thus forming a thermal oxide layer pattern 304. The first mask layer pattern 305 and the thermal oxide layer pattern 304 expose part of the surface of the silicon substrate 110. The terminals 140 are still covered with the first mask layer pattern 305. Thereafter, a second mask layer 306 is formed on the exposed surface of the silicon substrate 110 and the first mask layer pattern 305. The second mask layer 306 may be formed of a metal layer, for example, an aluminium (Al) layer.

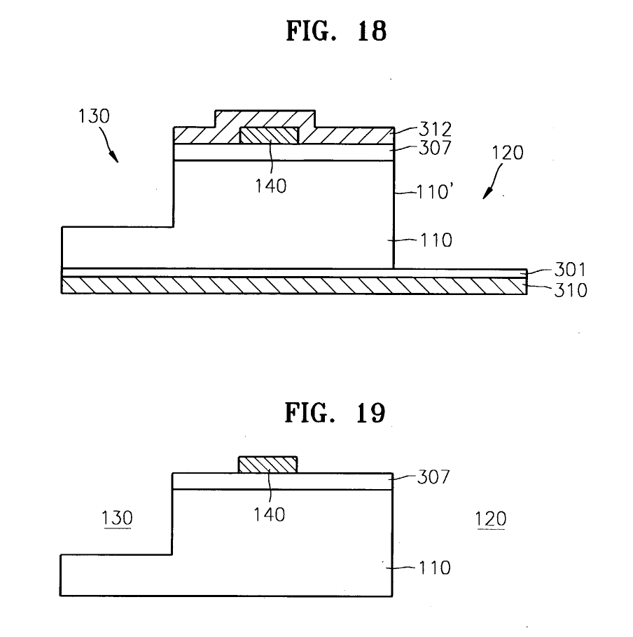

Referring to FIG. 16, the second mask layer 306 is patterned, thus forming a second mask layer pattern 309. Portions of the first mask layer pattern (305 of FIG. 15) exposed by the second mask layer pattern 309 are removed, thus forming a first mask layer pattern 308. Portions of the thermal oxide layer pattern (304 of FIG. 15) exposed by the second mask layer pattern 309 are removed, thus a thermal oxide layer pattern 307. The second mask layer pattern 309, the first mask layer pattern 308, and the thermal oxide layer pattern 307 expose part of the surface of the silicon substrate 110. A cavity, through which an optical switch device will be mounted on the silicon substrate 110, will be formed in the exposed part of the surface of the silicon substrate 110. The terminals 140 are still covered with the first mask layer pattern 308. Thereafter, a protective layer 310 is formed on the thermal oxide layer formed on the second surface 110b of the silicon substrate 110. The protective layer 310, like the first mask layer (303 of FIG. 14) may be formed of a nitride layer or an oxide layer through sputtering.

Referring to FIG. 17, an etching is performed on the silicon substrate 110 using the second mask layer pattern 309 as an etching mask so that the exposed part of the silicon substrate 110 is etched to a predetermined depth. Accordingly, a groove having a predetermined depth is formed in the silicon substrate 110. The exposed part of the silicon substrate 110 may be etched by an anisotropic wet etching method using a tetra-methyl-ammonium hydroxide (TMAH) solution and a KOH solution. The etching process, as shown in FIG. 20, is performed so that the direction of the etching process forms an angle of about 45 degrees with a flat zone 910 of a silicon wafer 900 in the (100) crystal orientation. Accordingly, it is possible to form the groove 311 to be perpendicular to a submount plane 110′ since an etched surface of the silicon substrate 110 is perpendicular to an anisotropic etching barrier, i.e., the (111) plane.

In some cases, the etching process may be performed using an inductively coupled plasma-reactive ion etching (ICP-RIE) method or a deep-reactive ion etching (D-RIE) method. The D-RIE method does not have any limitations in terms of an etching direction. Accordingly, an etched surface of the silicon substrate 110 is always perpendicular to the surface of the silicon substrate 110, irrespective of the etching direction of an etching process, and thus it is possible to form the groove 311 to be perpendicular to the submount plane 110′. Part of the silicon substrate 110 where the groove 311 is placed has a thickness d1 so that it can be removed by a subsequent etching process for forming grooves, in which a lens and an optical fiber will be installed.

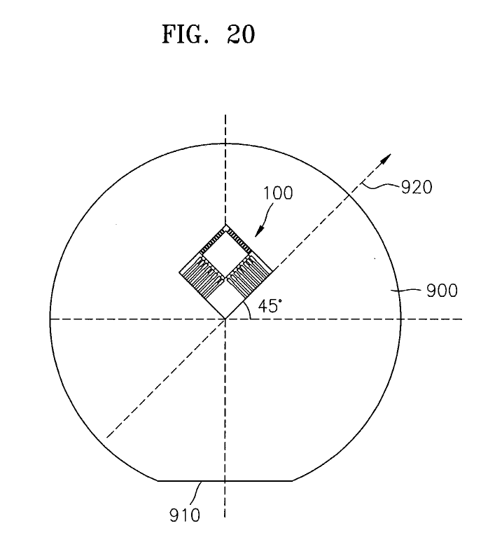

Referring to FIG. 18, the second mask layer pattern (309 of FIG. 17) is patterned again, thus forming a second mask layer pattern 312, through which part of the surface of the silicon substrate 110 is exposed. Thereafter, the exposed part of the silicon substrate 110 is removed by performing an etching process again using the second mask layer pattern 312 as an etching mask. The etching process is performed following a wet etching method using a TMAH solution and a KOH solution. As shown in FIG. 20, the etching process is performed so that the direction of the etching process forms an angle of about 45 degrees with the flat zone 910 of the silicon wafer 900 having the (100) crystal orientation. Accordingly, an etched surface of the silicon substrate 110 is perpendicular to the (111) plane, which is an anisotropic etching barrier of the silicon optical bench 100, and thus it is possible to form the cavity 120 to be perpendicular to the submount plane 110′.

In some cases, the etching process may be performed using an inductively coupled plasma-reactive ion etching (ICP-RIE) method or a deep-reactive ion etching (D-RIE) method. The D-RIE method does not have any limitations in terms of an etching direction. Accordingly, an etched surface of the silicon substrate 110 is always perpendicular to the surface of the silicon substrate 110, irrespective of the etching direction of an etching process, and thus it is possible to form the cavity 120 to be perpendicular to the submount plane 110′. When the etching process is completed, the cavity 120 is formed in one region exposed by the second mask layer pattern 312, and grooves 130 having a predetermined depth are formed in another region exposed by the second mask layer pattern 312.

Referring to FIG. 19, the second mask layer pattern 312 of FIG. 18 and the protective layer 310 are removed, and then the thermal oxide layer is removed. As a result of the removal, a silicon optical bench, including the cavity 120, through which an optical switch device will be installed, the terminals 140, and the grooves 130 for aligning a lens and an optical fiber, is completed.

As described above, according to a silicon optical bench of the present invention and an optical switch package using the silicon optical bench, grooves are formed in the silicon optical bench so that a path of incoming light beams and a path of outgoing light beams are defined by the grooves. In addition, an optical input unit or an optical output unit is automatically aligned with an optical switch device by installing a lens and an optical fiber in the grooves. Accordingly, it is possible to easily and precisely align unit devices with one another.

According to a method for fabricating a silicon optical bench of the present invention, patterns are formed on a (110) silicon substrate so that the patterns form an angle of 45 degrees with a crystal orientation of the (110) silicon substrate, and then an etching process is performed in consideration of the crystal orientation of the (110) silicon substrate. Alternatively, the (110) silicon substrate is perpendicularly etched using a D-RIE method. Accordingly, it is possible to prevent some part of the (110) silicon substrate from being etched unnecessarily. In addition, it is possible to reduce a loss in the quantity of light and the size of a device by decreasing the distance between an optical switch device and a lens.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A silicon optical bench for packaging an optical switch device, the silicon optical bench comprising a silicon substrate which includes a first region where the optical switch device will be installed, a second region placed on a first side of the first region so as to allow an optical input unit to be installed therein, and a third region placed on a second side of the first region so as to allow an optical output unit to be installed therein,
wherein a cavity is formed in the first region through the silicon substrate, and grooves are arranged in the second and third regions of the silicon substrate so that a lens and an optical fiber for defining optical fibers can be installed in the grooves.

2. The silicon optical bench of claim 1, wherein the silicon substrate has a rectangle shape.

3. The silicon optical bench of claim 1 further comprising a plurality of terminals arranged on the other two sides of the silicon substrate so that the plurality of terminals will contact electrodes of an optical switch device to be packaged.

4. The silicon optical bench of claim 3 further comprising alignment marks arranged on the silicon substrate between the plurality of terminals and the first region and used as an indication mark when aligning the optical switch device with the silicon substrate.

5. The silicon optical bench of claim 1, wherein the grooves are formed as a rectangle shape or a V-shape (or the grooves are formed to have a rectangle-shaped or V-shaped cross-section.

6. The silicon optical bench of claim 1 further comprising a groove for providing a path of parallel light beams, which is formed between the first region of the silicon substrate and the groove where the lens will be installed.

7. An optical package comprising:
an optical switch device which includes micromirrors arranged on its surface in a matrix and electrodes for driving the micromirrors formed along its edge; and
a silicon optical bench which includes a silicon substrate which includes a first region where the optical switch device will be installed, a second region placed on a first side of the first region so as to allow an optical input unit to be installed therein, and a third region placed on a second side of the first region so as to allow an optical output unit to be installed therein, a cavity formed in the first region through the silicon substrate, grooves arranged in the second and third regions of the silicon substrate so as to be aligned with an optical path, and a lens and an optical fiber for defining optical fibers.

8. The optical switch package of claim 7 further comprising a plurality of terminals arranged on the silicon substrate on sides of the silicon substrate opposite to the second and third regions so that the plurality of terminals contact electrodes of the optical switch device.

9. The optical switch package of claim 7, wherein the silicon optical further includes alignment marks arranged on the silicon substrate between the plurality of terminals and the first region and used as an indication mark when aligning the optical switch device with the silicon substrate.

10. The optical switch package of claim 7, wherein the silicon optical bench further includes a groove for providing a path of parallel light beams, which is formed between the first region of the silicon substrate and the groove where the lens will be installed.

11. The optical switch package of claim 7, wherein the lens and the optical fiber are integrated into one body.

12. The optical switch package of claim 7, wherein the optical switch device further includes a protector surrounding the micromirrors.

13. The optical switch package of claim 12, wherein the protector is made of glass.

14. A method for fabricating a silicon optical bench, comprising:
forming a thermal oxide layer on a first surface and a second surface of a silicon substrate having a (100) crystal orientation;
forming a metal layer pattern on the thermal oxide layer on the first surface of the silicon substrate;
forming a first mask layer pattern on the thermal oxide layer and the metal layer pattern on the first surface of the silicon substrate;
exposing a first region of the silicon substrate by removing part of the thermal oxide layer exposed by the first mask layer pattern using the first mask layer pattern as an etching mask;
forming a second mask layer on the exposed surface of the silicon substrate and the first mask layer pattern;
forming a second mask layer pattern by patterning the second mask layer;
exposing a second region of the silicon substrate by removing part of the first mask layer pattern and the thermal oxide layer using the second mask layer pattern as an etching mask;
forming a protective layer on the thermal oxide layer on the second surface of the silicon substrate;
performing a first etching process so as to etch the exposed part of the second region of the silicon substrate to a predetermined depth;
exposing the first region of the silicon substrate by removing part of the second mask layer pattern;
performing a second etching process so as to etch the exposed part of the first region of the silicon substrate to a predetermined depth and to completely remove the exposed part of the second region; and
removing the second mask layer pattern, the first mask layer pattern, and the protective layer.

15. The method of claim 14, wherein the first mask layer pattern and the protective layer are formed by forming a nitride layer or an oxide layer through sputtering.

16. The method of claim 14, wherein the second mask layer is formed of an aluminum layer.

17. The method of claim 14, wherein the first and second etching processes are performed using the second mask layer pattern as an etching mask by following a wet etching method using a TMAH solution and a KOH solution.

18. The method of claim 17, wherein the wet etching method is performed so that the direction of the etching process forms an angle of 45 degrees with a flat zone of a silicon wafer.

19. The method of claim 14, wherein the first and second etching processes are performed by using an inductively coupled plasma-reactive ion etching (ICP-RIE) method or a deep-reactive ion etching (D-RIE) method.
